(19) United States
(12) Patent Application Publication
(10) Pub. No.: US 2017/0344579 A1
(43) Pub. Date: Nov. 30, 2017

(54) DATA DEDUPLICATION

(71) Applicant: HEWLETT PACKARD ENTERPRISE DEVELOPMENT LP, Houston, TX (US)

(72) Inventors: Ranjith Reddy Basireddy, Bangalore (IN); Saji Sekhar Pariyarathodi, Bangalore (IN); Zameer Majeed, Bangalore (IN); Mahesh Shadaksharayya Kabbinakantimath, Bangalore (IN); Narendra Chirumamilla, Bangalore (IN)

(21) Appl. No.: 15/535,981

(22) PCT Filed: Feb. 13, 2015
(86) PCT No.: PCT/US2015/015867

§ 371 Date: Jun. 14, 2017

(30) Foreign Application Priority Data
Dec. 23, 2014 (IN) 6514/CHE/2014

(51) Int. Cl. G06F 17/30

(52) U.S. Cl. CPC G06F 17/30156; G06F 17/30097

(57) ABSTRACT

Some examples relate to data deduplication. In an example, upon addition or modification of a data unit in a data storage device, a Context Triggered Piecewise Hash (CTPH) key may be generated for an added or modified data unit. CTPH key of the added or modified data unit may be compared with a group CTPH key for each of a plurality of groups of data units stored in the data storage device to identify a group whose group CTPH key is within a pre-defined edit distance from the CTPH key of the added or modified data unit. A duplicate of the added or modified data unit may be identified within the identified group.

### BACKGROUND

Organizations may need to deal with a vast amount of data these days, which could range from a few terabytes to multiple petabytes of data. Storage systems therefore have become central to an organization's IT strategy not withstanding whether it is a small start-up or a large company. Storage devices or systems (often used interchangeably) are no longer perceived as just a piece of hardware, but rather devices that help meet present and future information needs of an organization.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing device for data deduplication;

FIG. 2 illustrates generation of a Context Triggered Piecewise Hash (CTPH) key for a data unit, according to an example;

FIG. 3 illustrates grouping of files on a data storage device, based on edit distance between CTPH keys of the files, according to an example;

FIG. 4 illustrates a comparison between CTPH keys, according to an example;

FIG. 5 is a flowchart of an example method for data deduplication; and

FIG. 6 is a block diagram of an example computer system for data deduplication.

### DETAILED DESCRIPTION

Increased adoption of technology by various businesses has led to an explosion of data. Enterprises are looking for efficient storage devices or systems to manage data growth and data storage costs. Many a time a storage system may contain duplicate or multiple copies of data. Minimizing the amount of data that needs to be stored in a storage system is one of the primary criteria for efficient storage systems. Eliminating redundant data not only helps in reducing storage hardware costs but also bandwidth costs whenever stored data needs to be transported over a network, for instance, for performing a backup or for meeting a compliance requirement.

Data deduplication is a technique for eliminating redundant data. Often, storage systems in an organization may contain duplicate copies of data. For example, a file (e.g., an email) may be saved in several different places by different users. Data deduplication reduces the amount of storage space required by an organization by eliminating such duplicate copies of files or blocks of data. In an example, data deduplication eliminates the additional copies, and saves just one copy of the data. The extra copies are replaced with pointers that lead back to the original copy.

In an example data deduplication approach, a hash algorithm may be applied to a data block to produce a hash code that identifies the data block. The hash code may be saved on a storage medium. Subsequently, when a new or modified data block is generated, in order to determine whether the new or modified data block is a duplicate of an existing data block, same hash algorithm is applied to the new or modified data block. The generated hash code is then compared with previously stored hash code(s). If a match is found, it indicates that data blocks represented by these hash codes are duplicates of each other. However, a drawback of this approach is that even a minor change in a similar data block would generate a different hash value which will preclude a traditional search algorithm from identifying a similar data block. Further, if a large number of hash code comparisons are needed to identify a duplicate data block, it may lead to an increased number of reads from the storage medium (to get keys into a memory) thereby leading to an inefficient duplicate detection process. Thus, it may be desirable (for example, in a dynamic environment where there may be continuous updates to data) to have an efficient mechanism to search data duplicates by eliminating unlikely candidates.

The present disclosure describes various examples for performing data deduplication in a storage system. In an example, a Context Triggered Piecewise Hash (CTPH) key may be generated for each data unit stored in a data storage system. Data units stored in the data storage system may be organized into a plurality of groups, wherein data units with same edit distance between their CTPH keys may be grouped together. A group CTPH key may be generated for each of the plurality of groups of data units, wherein CTPH keys of data units within a group may be used to generate the group CTPH key for a group. In the event, a new data unit is added or modified in the data storage system, a CTPH key may be generated for the newly added or modified data unit. The CTPH key of the newly added or modified data unit may be compared with the group CTPH key of each of the plurality of groups of data units to identify a group with a group CTPH key having an edit distance within a pre-defined threshold limit from the CTPH key of the added or modified data unit. The identified group may then be used to identify a duplicate of the newly added or modified data unit.

In an example, metadata of a data unit (for example, a file, a block, an object, etc.) may be segregated from metadata of a group of units, and reference of data units may be provided within the group. A comparison of group CTPH keys with CTPH key of a new or modified data unit via a quick disk read not only helps in eliminating large data sets but also aids in identifying a probable duplicate data unit faster. In an example, group metadata may be stored on a shared storage or file system and parallel processing may be performed for eliminating duplicates.

A large amount of data stored these days is in the form of data files or “files”, which are typically organized by a file system. A file system is an integral part of an operating system. It provides the underlying structure that a computing device uses to organize data on a storage medium. A computer file or “file” is the basic component of a file system. Each piece of data on a storage device may be called a “file”. A file may contain data, such as text files, image files, video files, and the like, or it may be an executable file or program. In an example, the proposed solution organizes data files into groups in a manner that reduces the search time required for identifying duplicate data files by quickly eliminating those groups of data files that may not have any common elements with the data being searched.

The term “data”, as used herein, may refer to include a unit of data i.e. a “data unit”, which may vary depending on the type of storage used. For example, a file may be considered as a data unit for a file-based storage. Similarly, a block may be considered as a data unit for block-based data storage. Likewise, an object may be considered as a data unit for an object-based storage. The aforementioned are just some non-limiting examples of a data unit.

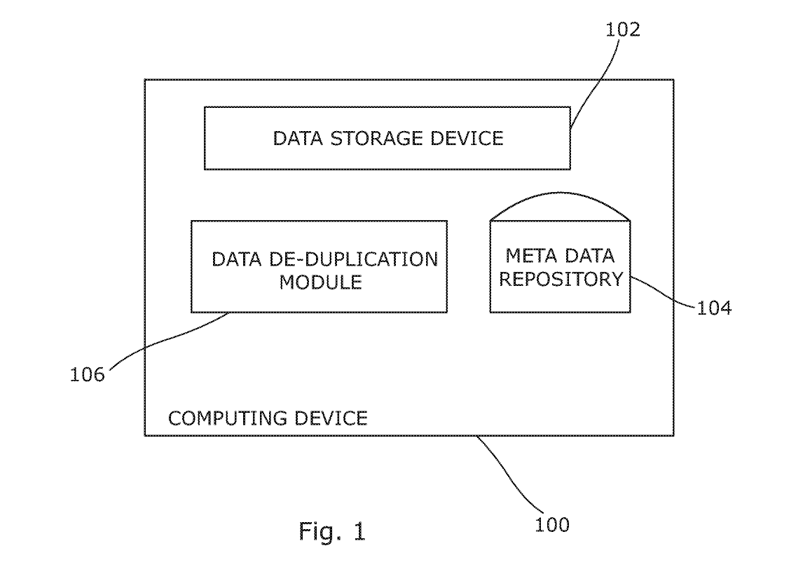

FIG. 1 is a block diagram of an example computing device 100 for facilitating data deduplication. Computing device 100 generally represents any type of computing system capable of reading machine-executable instructions. Examples of computing device may include, without limitation, a server, a desktop computer, a notebook computer, a tablet computer, a thin client, a mobile device, a personal digital assistant (PDA), a phablet, and the like.

In the example of FIG. 1, computing device 100 may include a data storage device, a metadata repository, and a data deduplication module. The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of computing device 100.

Data storage device 102 may be a primary storage device such as, but not limited to, random access memory (RAM), read only memory (ROM), processor cache, or another type of dynamic storage device that may store information and machine-readable instructions that may be executed by a processor. For example, Synchronous DRAM (SDRAM), Double Data Rate (DDR), Rambus DRAM (RDRAM), Rambus RAM, etc. Data storage device 102 may be a secondary storage device such as, but not limited to, a floppy disk, a hard disk, a CD-ROM, a DVD, a pen drive, a flash memory (e.g. USB flash drives or keys), a paper tape, an Iomega Zip drive, and the like. Data storage device 102 may be a tertiary storage device such as, but not limited to, a tape library, an optical jukebox, and the like. In an example, computing device 100 may a data storage system such as, by way of a few non-limiting examples, a Direct Attached Storage (DAS) device, a Network Attached Storage (NAS) device, a tape drive, a magnetic tape drive, a data archival storage system, or a combination of these devices. In another example, data storage device 102 may be a shared storage device, which may be accessible to multiple users on a network.

In an example, computing device 100 may be a data deduplication system. The term “data deduplication system”, as used herein, may refer to a system that reduces redundant data by storing only one unique instance of data on a storage device.

In the example of FIG. 1, a data storage device 102 may store multiple data units. The number of data units stored in the data storage device 102 may range from a few data units to thousands of data units. In an example, a Context Triggered Piecewise Hash (CTPH) key may be generated for each data unit stored in the data storage device 102. A CTPH key for data (such as, a data file) may be generated by using Context Triggered Piecewise Hashing (CTPH) algorithm. CTPH method, also known as Fuzzy Hashing, is a hashing function that tends to produce the same hash for similar input strings. A piecewise hashing involves using an arbitrary hashing algorithm (for example, MD5, SHA, etc.) to create multiple hashes for a data unit instead of just one. Instead of creating a single hash for the complete data unit, a hash is generated for many discrete fixed-size segments of the data unit. A CTPH method, however, uses a rolling hash method. A rolling hash method produces a pseudo-random value based only on the current context of the input. The rolling hash works by maintaining a state based solely on the last few bytes from the input. Each byte is added to the state as it is processed and removed from the state after a set number of other bytes have been processed.

CTPH method works by splitting a character string in chunks of variable length. A “chunk”, as defined herein, refers to a sequence of bytes, for which a hash key is computed. The end point of a chunk is determined by a rolling hash. When the output of the rolling hash produces a specific output, the traditional hash is triggered. In other words, while processing the input data unit, the traditional hash for the data unit is computed simultaneously with the rolling hash for the data unit. When the rolling hash produces a trigger value, the value of the traditional hash is recorded in the CTPH key and the traditional hash is reset. As a result, each recorded value in the CTPH key depends only on part of the input, and changes to the input results in only localized changes in the CTPH key. Each traditional hash value is mapped into one of the characters in a b64 character array.

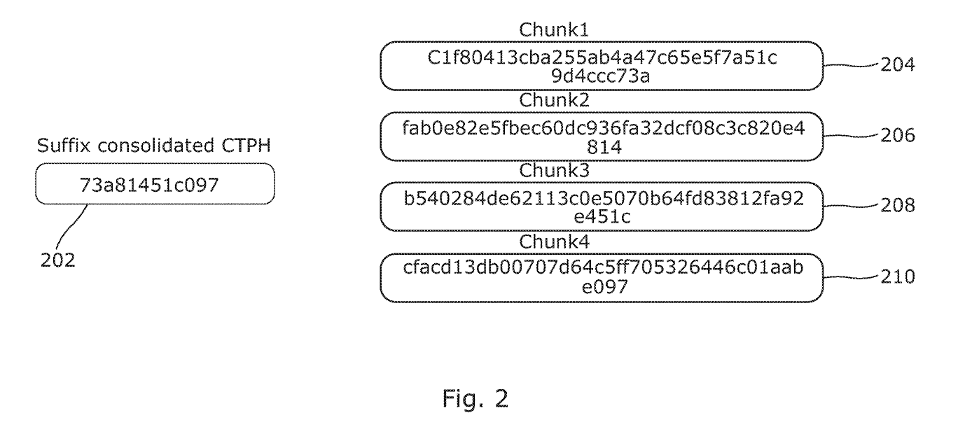

Thus, CTPH method makes use of the traditional hashes to create a segmented hash. A CTPH key representing a data unit may include a single string representing the sub-parts of hash value of each of the chunks. There are multiple ways of creating a CTPH key of a data unit out of the chunk hash keys. The method of creating a CTPH key for a data unit may vary. It may be based on, for instance, file type and other parameters such as, but not limited to, search speed, metadata, and memory. In an example, a CTPH key for a data unit may be created by using the last three digits of each of the hash keys generated for various chunks of the data unit, as illustrated in FIG. 2. FIG. 2 shows generation of a CTPH key 202 for a data unit from the last three digits of each of the hash keys 204, 206, and 210, generated for different chunks (i.e. Chunk 1, Chunk 2, Chunk 3, and Chunk 4) of the data unit. In an example, CTPH for a data unit may be stored as file metadata of a file system or as storage controller metadata.

In an example, once individual CTPH keys are generated for each data unit stored on a data storage device, data units stored on the data storage device may be organized into a plurality of groups based on edit distance. Edit distance is a mechanism of determining how dissimilar two strings (for example, words) are to one another by counting the minimum number of operations required to transform one string into the other. An “operation” may include an insertion, deletion, or substitutions of a single character. Edit distance may be used to measure the similarity between two CTPH keys or digests (for example, of data files). Edit distance between twp CTPH keys may be calculated by using various methods such as, but not limited to, Levenshtein distance, and Hamming distance. Edit distance may also be calculated by using a custom method depending on how a CTPH key is generated. The method of calculating an edit distance may vary, and may be made more efficient by using methods customized to the way a CTPH key itself is generated.

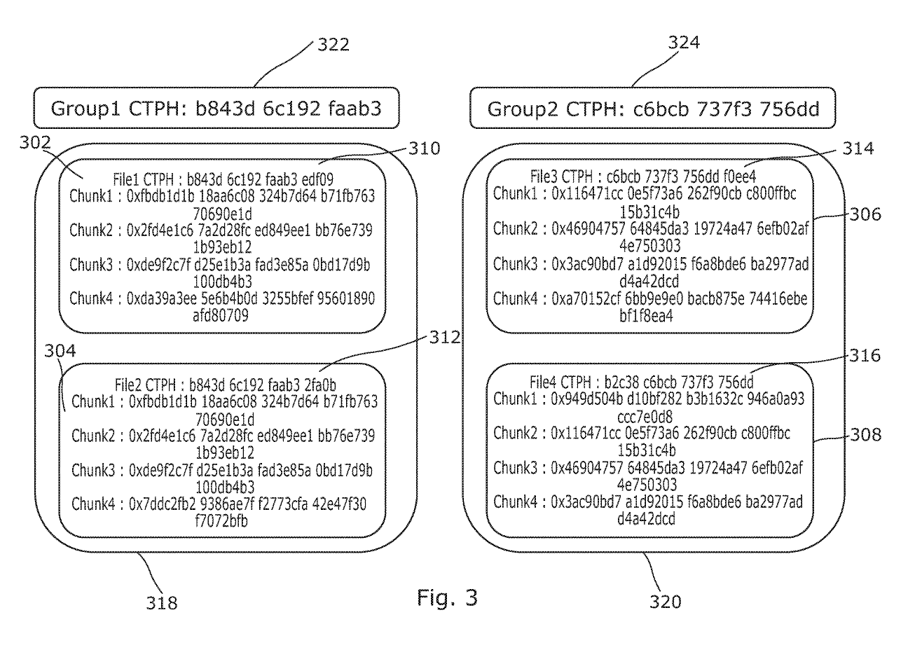

In an example, data units with same edit distance between their respective CTPH keys are grouped together on a data storage device. Thus, data units stored on the data storage device (for example, 102) may be organized into a plurality of groups based on edit distance between their CTPH keys. Data units with similar edit distance between their CTPH keys may be grouped together. FIG. 3 illustrates grouping of files on a data storage device (for example, 102), based on edit distance between CTPH keys of the data units, according to an example. Assuming there are four files (File 1, File 2, File 3, and File 4) 302, 304, 306, and 308, each having four chunks, that are stored on a data storage device (for example, 102), hash keys may be computed for all chunks of the four files. Then, a CTPH key 310, 312, 314, and 316, may be computed for each of the four files by considering, for example, every eighth byte of hash keys generated for all chunks of the files. Edit distance between CTPH keys of the files is determined to organize the files into different groups. In the present case, since edit distance between File 1 and File 2 is same, they are grouped together into one group i.e. Group 1 (318). Likewise, since edit distance between File 3 and File 4 is same, they are grouped together into another group i.e. Group 2 (320).

Once data units stored on a data storage device (for example, 102) are organized into a plurality of groups based on edit distance, a group CTPH key may be generated for each of the plurality of groups of data units. CTPH method may be used to generate a group CTPH key (or digest) for a group. In an example, individual CTPH keys of files within a group may be used to generate a group CTPH key for the group. This is illustrated in FIG. 3, according to an example. A group CTPH key 322 for Group 1 may be generated based on CTPH keys of files 1 and 2. Likewise, a group CTPH key 324 for Group 2 may be generated based on CTPH keys of files 3 and 4. In an instance, a group CTPH key for a group of files (i.e. group CTPH key) may be stored as file metadata of a file system or as storage controller metadata.

Metadata repository 104 may store a CTPH key of a data unit stored in a data storage device. Metadata repository 104 may store a group CTPH key for a group of data units stored in a data storage device, wherein the group CTPH key may be generated from CTPH keys of data units present within the group. In an example, metadata repository 104 may be file metadata of a file system. In another example, metadata repository 104 may be storage controller metadata.

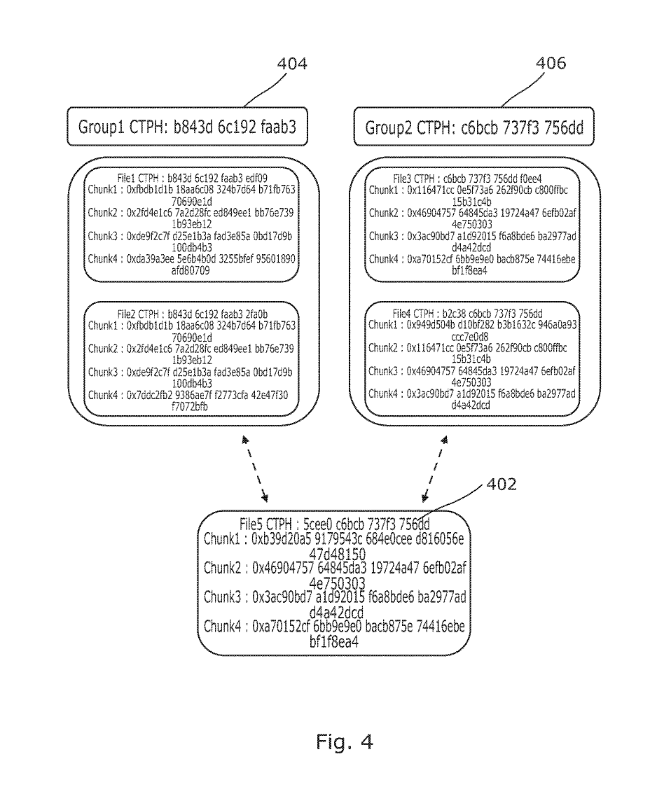

In an example, data deduplication module 106 may generate, upon addition or modification of a data unit in a data storage device (for example, 102), a CTPH key for the added or modified data unit. In other words, if a new data unit is created or added to a data storage device, or an existing data unit is modified in the data storage device, data deduplication module 106 may generate a CTPH key, using CTPH method (described earlier) for the new or modified data unit. Data deduplication module 106 may then compare the CTPH key of the newly added or modified data unit with the group CTPH key of each of the plurality of groups of data units, stored in a data storage device (for example, 102), to identify a group with a group CTPH key having an edit distance within a pre-defined threshold limit from the CTPH key of the new or modified data unit. In other words, data deduplication module 106 may compare the CTPH key of the new or modified data unit, as the case may be, with group CTPH keys of groups of data units to identify a group CTPH key that has an edit distance within a pre-defined threshold limit. Such comparison leads to identification of a group(s) of data units that is/are most likely to have common or duplicate data with the newly created or modified data unit. A threshold limit for an edit distance may be pre-defined for making a comparison between CTPH key of the new or modified data unit with various group CTPH keys. In an example, a threshold limit may represent a minimum number of common elements (for example, character strings) between CTPH key of the new or modified data unit and a group CTPH key, for a group representing the group CTPH to be identified as a likely candidate that may have common or duplicate data with the newly created or modified data unit. For instance, if the threshold limit is defined as 3, then there should be at least three common elements between CTPH key of the new or modified data unit and a group CTPH key, for a group representing the group CTPH to be identified as a likely candidate that may have common or duplicate data with the newly created or modified data unit. This is illustrated in FIG. 4, according to an example. FIG. 4 shows a comparison between CTPH key 402 of a newly added file “File 5” with group CTPH keys 404 and 406 of Group 1 and Group 2. Upon comparison, it is determined that edit distance between CTPH key of “File 5” and group CTPH key of Group 1 is 4 (i.e. no elements match between the two CTPH keys). On the other hand, edit distance between CTPH key of “File 5” and group CTPH key of Group 2 is 1 (i.e. 3 elements match between the two CTPH keys). Upon comparison of the edit distances, a determination may be made that Group 2 is most likely to have common or duplicate data with “File 5”.

In an example, the threshold limit may be a value that represents a percentage of common characters between strings of CTPH keys under comparison. In such case, if edit distance between CTPH key of a new (or modified data unit) and a group CTPH key is more than a pre-defined percentage, data deduplication module 106 may identify the group. In the event, if edit distance between CTPH key of a new (or modified data unit) and a group CTPH key is less than a pre-defined percentage, data deduplication module may disregard the group. In like manner, data deduplication module 106 may compare the CTPH key of the newly added or modified data unit with all group CTPH keys to identify a group with a group CTPH key that has an edit distance within a pre-defined threshold limit from the CTPH key of the new or modified data unit. In an instance, data deduplication module 106 may perform this comparison by obtaining data for group CTPH keys from metadata repository (for example, 104).

Once a group of data units having group CTPH key that has an edit distance within a pre-defined threshold limit from the CTPH key of the new or modified data unit is identified, data deduplication module may use the identified group to identify a duplicate of the newly added or modified data unit. In an example, a duplicate data unit of the newly added or modified data unit may be identified by comparing the CTPH key of the newly added or modified data unit with the CTPH key of each data unit within the identified group to identify a data unit with a CTPH key having an edit distance within a pre-defined threshold limit from the CTPH key of the added or modified data unit. In other words, individual CTPH keys of the data units with an indentified group(s) may be compared with the CTPH key of a newly added or modified data unit to identify a data unit with a CTPH key having an edit distance within a pre-defined threshold limit from the CTPH key of the added or modified data unit. Such comparison leads to identification of data unit(s) that is/are most likely to have common or duplicate data with the newly created or modified data unit. A threshold limit for an edit distance may be pre-defined for making a comparison between CTPH key of the new or modified data unit with CTPH keys of various data units within an identified group. In an example, a threshold limit may represent a minimum number of common elements (for example, character strings) between CTPH key of the new or modified data unit and a data unit CTPH key, for a data unit representing the data unit CTPH to be identified as a likely candidate that may have common or duplicate data with the newly created or modified data unit. For instance, if the threshold limit is defined as 3, then there should be at least three common elements between CTPH key of the new or modified data unit and a data unit CTPH key, for a data unit representing the data unit CTPH to be identified as a likely candidate that may have common or duplicate data with the newly created or modified data unit.

In an example, the threshold limit may be a value that represents a percentage of common characters between strings of CTPH keys under comparison. In such case, if edit distance between CTPH key of a new (or modified data unit) and a data unit CTPH key is more than a pre-defined percentage, data deduplication module 106 may identify the data unit. In the event, if edit distance between CTPH key of a new (or modified data unit) and a data unit CTPH key is less than a pre-defined percentage, data deduplication module 106 may disregard the data unit. In like manner, data deduplication module 106 may compare the CTPH key of the newly added or modified data unit with all data unit CTPH keys (within an identified group(s)) to identify a data unit with a data unit CTPH key that has an edit distance within a pre-defined threshold limit from the CTPH key of the new or modified data unit. In an instance, data deduplication module 106 may perform this comparison by obtaining data for data unit CTPH keys from metadata repository (for example, 104).

Once a data unit having a data unit CTPH key that has an edit distance within a pre-defined threshold limit from the CTPH key of the new or modified data unit is identified, such data unit may be identified as duplicate data unit of the newly added or modified data unit. In an example, prior to such identification, data deduplication module 106 may compare individual chunks of the newly added or modified data unit with individual chunks of the identified data unit to identify common data elements. Such comparison may further corroborate that an identified data unit(s) is a duplicate of the newly added or modified data unit.

Once a duplicate data unit(s) of a newly added or modified data unit is identified, the duplicate data unit may be deleted by the data deduplication module 106. In an example, a user may be given an option to delete a duplicate data unit. In an instance, a duplicate data unit may be replaced with a pointer to the added or modified data unit.

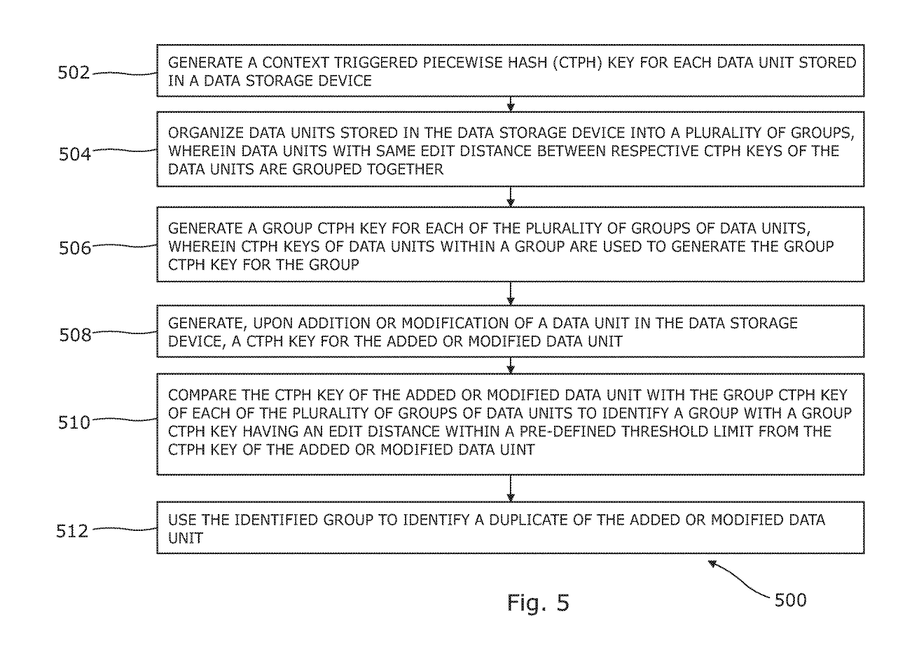

FIG. 5 is a flowchart of an example method for data deduplication. The method 500, which is described below, may at least partially be executed on a computing device 100 of FIG. 1. However, other computing devices may be used as well. At block 502, a Context Triggered Piecewise Hash (CTPH) key may be generated for each data unit stored in a data storage device. At block 504, data units stored in the data storage device may be organized into a plurality of groups, wherein data units with same edit distance between respective CTPH keys of the data units are grouped together. At block 506, a group CTPH key may be generated for each of the plurality of groups of data units, wherein CTPH keys of data units within a group are used to generate the group CTPH key for the group. At block 508, upon addition or modification of a data unit in the data storage device, a CTPH key may be generated for the added or modified data unit. At block 510, the CTPH key of the added or modified data unit may be compared with the group CTPH key of each of the plurality of groups of data units to identify a group with a group CTPH key having an edit distance within a pre-defined threshold limit from the CTPH key of the added or modified data unit. At block 510, the identified group may be used to identify a duplicate of the added or modified data unit.

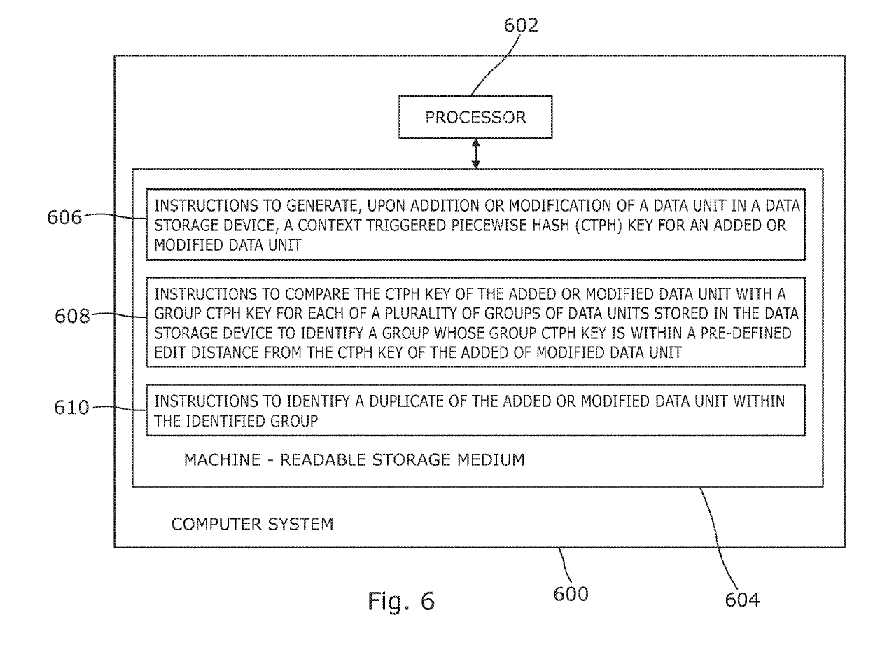

FIG. 6 is a block diagram of an example system 600 for data deduplication. System 600 includes a processor 602 and a machine-readable storage medium 604 communicatively coupled through a system bus. In an example, system 600 may be analogous to computing device 100 of FIG. 1. Processor 602 may be any type of Central Processing Unit (CPU), microprocessor, or processing logic that interprets and executes machine-readable instructions stored in machine-readable storage medium 604. Machine-readable storage medium 604 may be a random access memory (RAM) or another type of dynamic storage device that may store information and machine-readable instructions that may be executed by processor 602. For example, machine-readable storage medium 604 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 604 may be a non-transitory machine-readable medium. Machine-readable storage medium 604 may store instructions 606, 608, and 610. In an example, instructions 606 may be executed by processor 602 to generate, upon addition or modification of a data unit in a data storage device, a Context Triggered Piecewise Hash (CTPH) key for an added or modified data unit. Instructions 608 may be executed by processor 602 to compare the CTPH key of the added or modified data unit with a group CTPH key for each of a plurality of groups of data units stored in the data storage device to identify a group whose group CTPH key is within a pre-defined edit distance from the CTPH key of the added or modified data unit. Instructions 610 may be executed by processor 602 to identify a duplicate of the added or modified data unit within the identified group.

In an example, instructions to compare the CTPH key of the added or modified data unit with a group CTPH key for each of the plurality of groups of data units includes instructions to send a single input/output (I/O) request to the metadata repository. In an example, instructions to identify the duplicate of the added or modified data unit within the identified group comprises instructions to compare the CTPH key of the added or modified data unit with a CTPH key of each data unit within the identified group to identify a data unit whose CTPH key is within a pre-defined edit distance from the CTPH key of the added or modified data unit.

For the purpose of simplicity of explanation, the example method of FIG. 5 is shown as executing serially, however it is to be understood and appreciated that the present and other examples are not limited by the illustrated order. The example systems of FIGS. 1 and 6, and method of FIG. 5 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method of data deduplication, comprising:
generating a Context Triggered Piecewise Hash (CTPH) key for each data unit stored in a data storage device;
organizing data units stored in the data storage device into a plurality of groups, wherein data units with same edit distance between respective CTPH keys of the data units are grouped together;
generating a group CTPH key for each of the plurality of groups of data units, wherein CTPH keys of data units within a group are used to generate the group CTPH key for the group;
generating, upon addition or modification of a data unit in the data storage device, a CTPH key for the added or modified data unit;
comparing the CTPH key of the added or modified data unit with the group CTPH key of each of the plurality of groups of data units to identify a group with a group CTPH key having an edit distance within a pre-defined threshold limit from the CTPH key of the added or modified data unit; and
using the identified group to identify a duplicate of the added or modified data unit.

2. The method of claim 1, wherein identifying the duplicate of the added or modified data unit, comprises:
comparing the CTPH key of the added or modified data unit with the CTPH key of each data unit within the identified group to identify a data unit with a CTPH key having an edit distance within a pre-defined threshold limit from the CTPH key of the added or modified data unit.

3. The method of claim 2, further comprising comparing a chunk of the added or modified data unit with a chunk of the identified data unit to identify common data elements.

4. The method of claim 1, further comprising replacing the duplicate of the added or modified data unit with a pointer to the added or modified data unit.

5. The method of claim 1, further comprising storing the Context Triggered Piecewise Hash (CTPH) key for each data unit and the Context Triggered Piecewise Hash (CTPH) key for each of the plurality of groups.

6. The method of claim 5, wherein the Context Triggered Piecewise Hash (CTPH) key for each data unit and the Context Triggered Piecewise Hash (CTPH) key for each of the plurality of groups is stored as file metadata.

7. The method of claim 5, wherein the Context Triggered Piecewise Hash (CTPH) key for each data unit and the Context Triggered Piecewise Hash (CTPH) key for each of the plurality of groups is stored as storage controller metadata.

8. A system for data deduplication, comprising:
a data storage device, wherein data units stored in the data storage device are organized into a plurality of groups, wherein data units with same edit distance between Context Triggered Piecewise Hash (CTPH) keys of the data units are grouped together;
a metadata repository to store a group CTPH key for each of the plurality of groups of data units in the data storage device, wherein the group CTPH key for a group of data units is generated from CTPH keys of data units within the group; and
a data deduplication module to:
generate, upon addition or modification of a data unit in the data storage device, a CTPH key for an added or modified data unit;
compare the CTPH key of the added or modified data unit with the group CTPH key for each of the plurality of groups of data units to identify a group with a group CTPH key having an edit distance within a pre-defined threshold limit from the CTPH key of the added or modified data unit; and
identify a duplicate of the added or modified data unit within the identified group.

9. The system of claim 8, wherein:
the metadata repository further to store a CTPH key for each data unit present in the identified group; and
the data deduplication to use the CTPH key for each data unit present in the identified group to identify the duplicate of the data unit within the identified group.

10. The system of claim 8, wherein the metadata repository further to store a CTPH key for each data unit stored in the data storage device.

11. The system of claim 8, wherein the data storage device is a shared storage device.

12. A non-transitory machine-readable storage medium comprising instructions for data deduplication, the instructions executable by a processor to:
generate, upon addition or modification of a data unit in a data storage device, a Context Triggered Piecewise Hash (CTPH) key for an added or modified data unit:
compare the CTPH key of the added or modified data unit with a group CTPH key for each of a plurality of groups of data units stored in the data storage device to identify a group whose group CTPH key is within a pre-defined edit distance from the CTPH key of the added or modified data unit; and
identify a duplicate of the added or modified data unit within the identified group.

13. The storage medium of claim 12, wherein the CTPH key for each of the plurality of groups of data units is stored in a metadata repository.

14. The storage medium of claim 13, wherein instructions to compare the CTPH key of the added or modified data unit with a group CTPH key for each of the plurality of groups of data units includes instructions to send a single input/output (I/O) request to the metadata repository.

15. The storage medium of claim 13, wherein the instructions to identify the duplicate of the added or modified data unit within the identified group comprises instructions to compare the CTPH key of the added or modified data unit with a CTPH key of each data unit within the identified group to identify a data unit whose CTPH key is within a pre-defined edit distance from the CTPH key of the added or modified data unit.
